(19) United States
(12) Patent Application Publication
(10) Pub. No.: US 2008/0204212 A1
(43) Pub. Date: Aug. 28, 2008

(54) Method and Device For Driver Support

(76) Inventors: Ruediger Jordan, Stuttgart (DE); Carsten Schmitz, Wasserburg (DE); Andreas Josef Birnesser, Rheinmuenster (DE)

Correspondence Address: KENYON & KENYON LLP, ONE BROADWAY, NEW YORK, NY, 10004, US

(21) Appl. No.: 11/664,568

(22) PCT Filed: Aug. 17, 2005
(86) PCT No.: PCT/EP05/54048

§ 371 Date: Dec. 14, 2007

(30) Foreign Application Priority Data
Oct. 1, 2004 (DE) 10 2004 048 009.5

(51) Int. Cl. B60Q 1/00; B60Q 1/34

(52) U.S. Cl. 340/438; 340/475; 340/476

(57) ABSTRACT

In a method and a device for driver support, a directional indicator, e.g., the blinker of the vehicle, is actuated when there is a recognized lane change and a lane-change intention is present.

### FIELD OF THE INVENTION

The present invention relates to a method and a device for driver support, e.g., for support when changing lanes.

### BACKGROUND INFORMATION

Driver assistance systems help the driver react quickly and correctly in critical situations. Examples include, e.g., lane departure warning systems (LDW), which support the driver during lateral guidance of the vehicle. In such assistance systems, a change of lane is recognized, and a reaction takes place at least in the case of an unintentional change of lane on the part of the driver. German Published Patent Application No. 102 38 215, for example, describes procedures with the aid of which unintentional and intentional lane changes are distinguished from one another. Such a distinction also plays a part in connection with other driver assistance systems, e.g., adaptive vehicle speed regulating systems (Adaptive Cruise Control: ACC).

### SUMMARY

Through the turning on of a signal indicating the change of lane, for example, a blinker, in the case of intentional lane changes, other drivers in traffic are alerted of the intended lane change, thus increasing overall traffic safety.

In addition, the driver assistance system may achieve an increase in driving comfort, because the driver no longer has to indicate his desire to change lanes by turning on the blinker. This task is taken over by the driver assistance system.

The turning on of the vehicle's directional indicator by the driver assistance system may take place only if the directional indicator has not already been turned on by the driver.

After the change of lane has been completed, the directional indicator may be deactivated, if this has not been done by the driver himself.

Further features and aspects of example embodiments of the present invention are described in more detail below in the following description with reference to the appended Figures.

### BRIEF DESCRIPTION OF THE DRAWINGS

FIG. 1 shows an overview of a processing unit in which the lane change recognition is carried out. This processing unit is shown for the example of a lane departure warning system.

In FIG. 2, a flow diagram is shown that represents a basic procedure for lane change classification in connection with the lane departure warning system.

FIG. 3 depicts a flow diagram that shows an exemplary embodiment for the setting or resetting of the directional indicator.

FIG. 4 shows the modular construction of the processing unit of a lane departure warning system, in which the setting of the directional indicator is realized.

### DETAILED DESCRIPTION

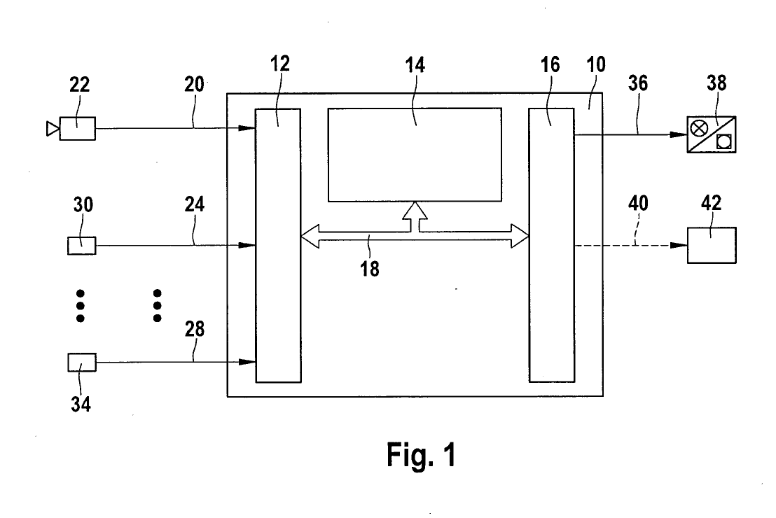

FIG. 1 shows a device that forms part of a system for driver support (e.g., for warning and/or for controlling an actuating element for lateral guidance of the vehicle upon departure or threatened departure from a lane). Depicted is a control or evaluation unit 10 that has at least one input circuit 12, a microcomputer 14, and an output circuit 16. These elements are connected to a bus system 18 for mutual data exchange. Input circuit 12 is supplied with input lines from various measurement devices, via which measurement signals or measurement information can be communicated. A first input line 20 connects input circuit 12 to an image sensor system 22 that records the scene in front of the vehicle. Corresponding image data are transmitted via input line 20. In addition, input lines 24 to 28 are provided that connect input circuit 12 to measurement devices 30 to 34. These measurement devices include, for example, devices for measuring the speed of the vehicle, for acquiring the steering angle and/or the yaw rate, for acquiring a quantity that represents the driver's desired acceleration, for example, the degree to which the driver actuates the gas pedal, for acquiring the speed and/or the acceleration of the vehicle, and for acquiring additional operating quantities of the vehicle that are significant in connection with the procedure described below. Via output circuit 16 and output line 36, at least one warning device 38 is controlled, for example, a warning lamp and/or a loudspeaker for an acoustic warning and/or for a speech output and/or a display for displaying an image and/or an actuating element for a haptic indication with the aid of which the driver is informed of the (threatened) departure from the lane. In addition, or alternatively, in some exemplary embodiments, it is provided to control, via output circuit 16 and an output line 40, an actuating system 42 that automatically guides the vehicle back into the lane (lateral guidance), for example, by intervening in the steering system of the vehicle, thus preventing departure from the lane.

Using image analysis methods, in the exemplary embodiment of the lane departure warning system image data supplied by the image sensor system concerning the scene in front of the vehicle are used to determine lane data that represent the course and the size of the lane. Thus, for example, the lane edge markings (left and/or right lane edge) are acquired, and the course of the respective lane edge is approximated, for example, as a polynomial (third-order power function). In addition, the course of the vehicle's lane, e.g., for the right and/or left wheel, is calculated from vehicle geometric quantities, the current and possibly past quantities of vehicle speed, steering angle or yaw rate, etc., and is also represented as a polynomial. From these data, additional lane data are calculated, for example, the lateral distance between the lane marking and the lane of the vehicle (right side to right edge, left side to left edge), the curvature of the lane, and/or the angle between the lane and the lane marking (right lane to right edge, left lane to left edge), on the basis of tangent comparisons. From these data, in an example embodiment, the expected time until line crossing may also be calculated. In an exemplary embodiment, the warning takes place upon exceeding of a predetermined lateral distance, or upon undershooting of a predetermined time value.

In such a function, the driver is warned only if he does not intend to cross over the lane marking.

FIG. 2 shows a flow diagram in which the depicted lane departure warning system is supplemented by a classifier that evaluates the lane change situation on the basis of vehicle operating quantities, and classifies them as “unintentional change of lane” or “intentional change of lane.” The flow diagram in FIG. 2 depicts a corresponding program that is executed in the microcomputer of the device depicted in FIG. 1, e.g., at predetermined time intervals. In first step 100, the lane data depicted above are read in (once for one side of the vehicle, and in a separate pass for the other side of the vehicle), i.e., the course of the lane edge marking, the course of the actual vehicle lane, a quantity for the lateral distance between the vehicle and the lane edge, a quantity for the angle between the vehicle lane and the edge of the vehicle, additional operating quantities named above, etc. In the subsequent step 102, it is checked whether a departure from the lane is taking place or threatens to take place. If this is not the case, the program terminates and is executed again from the beginning with the next time interval, with step 100. If a departure or threatened departure is recognized, in step 104, the classifier determines, on the basis of operating quantities, whether the lane change is intentional or unintentional. It is thereupon checked in step 106 whether the departure from the lane is intentional or not. If it is intentional, the warning or lateral guidance reaction is not carried out, and the program is repeated from step 100. However, if it is recognized that the departure from the lane is unintentional, then according to step 108 a warning takes place optically, acoustically, and/or haptically, or a lane-holding reaction is executed, e.g., the controlling of an actuating element for influencing the steering.

Various realizations of the classification are conventional. The basic procedure for classification is based on the evaluation of at least two vehicle operating quantities, on the basis of which the behavior of the driver can be inferred. Operating quantities that are suitable for this purpose include, for example, the steering angle (alternatively, the yaw rate), the speed of the vehicle or its acceleration or retardation, the lateral offset between the vehicle lane and the edge of the lane, e.g., changes therein, and/or the angle of the vehicle lane to the edge of the roadway. With regard to the steering angle, the steering behavior is checked, which is clearly recognizable if there is an intention to change lanes. A steering angle greater than a predetermined value, e.g., a corresponding temporal change in the steering angle, indicates an intention to change lanes. During curved travel, the determined roadway curvature is to be taken into account. In addition, when there is an intention to change lanes, e.g., to the left, there is usually an acceleration of the vehicle, so that given an acceleration of the vehicle, or a desired acceleration of the part of the driver, that is greater than a predetermined threshold value, an intentional lane change is to be assumed. Another suitable quantity is the lateral distance of the vehicle from the lane marking, e.g., the temporal change thereof. This represents a measure of the magnitude with which a vehicle is approaching the lane edge marking. In the case of intentional lane changes, this measure is significantly greater than in the case of unintentional lane changes. The same holds correspondingly for the angle to the lane marking, which is significantly greater for intentional lane changes than for unintentional ones.

In sum, it is to be noted that a classification of the lane change process into unintentional and intentional lane changes takes place on the basis of vehicle operating quantities, e.g., if the steering angle exceeds a threshold value and/or the driver's desired acceleration exceeds a threshold value and/or the temporal curve of the lateral distance to the edge marking exceeds a threshold value and/or the angle to the edge marking exceeds a threshold value. These criteria are used in weighted fashion for the classification of the lane change process into intentional and unintentional changes of lane. In general, an intentional lane change is recognized when at least one of the described situations is present, and if none of them is present, an unintentional lane change is recognized.

Through the classification, it is therefore recognized with high probability whether a change of lane is taking place intentionally or unintentionally.

In an exemplary embodiment, neural networks are suitable for the realization of the classifier in accordance with the procedure described above. In an exemplary embodiment, an MLP network (multilayer perceptron) may be suitable. The quantities described above for the left and for the right side are supplied to this neural network. According to the weights (threshold values) assigned to the individual neurons, the neural network forms an output quantity that indicates an intentional or unintentional change of lane.

A second possible realization consists in the specification of concrete conditions for the individual quantities from whose presence an intentional or an unintentional change of lane is derived. In order to make the decision more reliable, a combination of the criteria is to be used at least in unclear cases. If, for example, the angle to the lane upon lane contact is greater than 4°, inattentiveness of the driver can be ruled out as long as no significant lane curvature is present. Correspondingly, for each quantity used a corresponding decision rule can be formed. For the remaining situations, which do not yield an unambiguous result with any decision rule, on the basis of a remaining feature (for example the temporal change of the distance to the lane boundary) a definite decision is made as to whether an intentional or an unintentional change of lane is taking place. The decision criteria, or at least their weighting, are as a rule different for the left side and the right side.

In addition, for example, from the document mentioned above, other procedures are also conventional for distinguishing an intentional change of lane from an unintentional one. In these other procedures, on the basis of the attentiveness of the driver the lane-change intention is determined, using the assumption that if the driver is attentive an intentional change of lane is taking place.

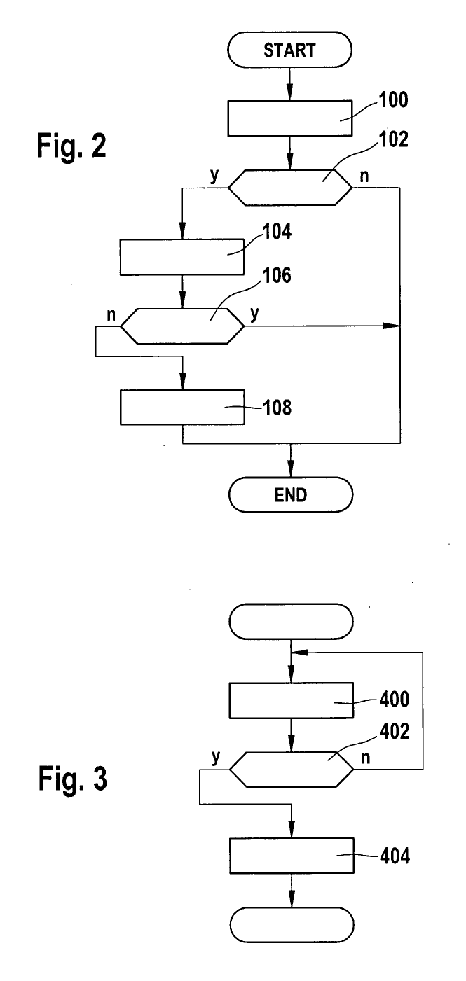

If a lane-change intention has been recognized in one of the manners described above, the program depicted in FIG. 3 is started. Unless the driver has already done so, in step 400, the vehicle blinker is activated on the side of the vehicle towards which the lane change is taking place. This information is communicated upon determination of the lane change, based on the vehicle course and the roadway edge marking.

Subsequently, in step 402, it is checked whether the change of lane has been concluded or not. A concluded change of lane is recognized in that the vehicle is situated between two edge markings of a lane, or, in an example embodiment, after the elapsing of a predetermined time period. This is determined through analysis of the image from the video camera of the lane departure warning system, from which the position of the vehicle within the lane can be calculated. If the change of lane has not concluded, the controlling of the blinker is maintained according to step 400. If the change of lane has concluded, according to step 404, the controlling of the blinker is terminated, i.e., the blinker is deactivated and the program depicted in the Figure is terminated.

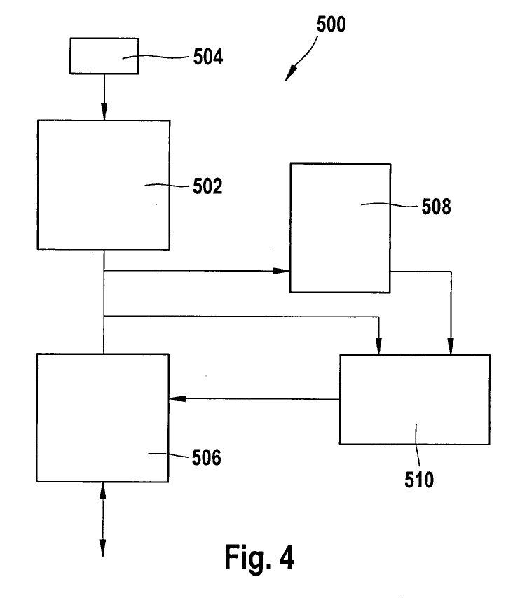

FIG. 4 shows the construction of processing unit 500, having a plurality of program modules. For the procedure described above, the processing unit has a first program module 502 that includes the lane recognition software. This program module receives images, recorded by a camera 504, of the scene in front of the vehicle, and processes these images in the sense of the above-described procedure for recognizing the roadway edge lines, the lateral distance to the edge lines, the curvature of the lines, the angle to the lines, etc. In addition, a connection module 506 to a bus system of the vehicle, for example, CAN, is also part of the processing unit. Via this bus system, the processing unit is supplied with operating quantities such as steering angle, gas pedal position, brake actuation, yaw rate, etc. The operating quantities transmitted via CAN are communicated to module 502 for determining vehicle course, speed, etc. There, this information is evaluated together with the information of the image processing unit for recognizing a lane change of the vehicle, for example, on the basis of the reduction of the lateral distance, or on the basis of the time until reaching the roadway edge marking. If module 502 recognizes a change of lane, this information is supplied to a module 508. This module recognizes the intention to change lanes (Lane-change intention Discrimination). Besides the information concerning an imminent or achieved departure from the lane, via the bus system this module is also supplied with the necessary additional information that forms the basis for the execution of one of the above-described procedures for recognizing a lane-change intention. When a lane-change intention has been recognized, module 508 then communicates the corresponding information to a module 510. Module 502 provides the information about the recognized lane change to this module 510. On the basis of the supplied quantities, as shown, for example, in FIG. 3, module 510 then determines whether a blinker is to be turned on or not. If a blinker is to be turned on, module 510 emits a corresponding signal via bus module 506, through which the directional indicator of the vehicle is actuated, or, if the lane change has been completed (corresponding information coming from module 502), is turned off.

1-7. (canceled)

8. A method for driver support, comprising:
determining at least one of (a) a change of lane and (b) an imminent change of lane of a vehicle; and
actuating a directional indicator of the vehicle for a change of lane intended by a driver.

9. The method according to claim 8, wherein the directional indicator includes a blinker of the vehicle.

10. The method according to claim 8, wherein the directional indicator is actuated in the actuating step on a side at which the change of lane is taking place.

11. The method according to claim 8, further comprising:
detecting an end of a lane change; and
deactivating the directional indicator when an end of the lane change is detected.

12. The method according to claim 8, wherein the directional indicator is actuated in the actuating step only if a change of lane is detected and a lane-change intention is present.

13. The method according to claim 8, wherein for an unintentional lane change, the directional indicator is not actuated, but the driver is warned.

14. The method according to claim 8, wherein the directional indicator is actuated in the actuating step only if the driver has not carried out an actuation of the directional indicator.

15. A device for driver support, comprising:
a processor unit configured to detect a change of lane of a vehicle, to determine a lane-change intention, and to actuate a directional indicator of the vehicle is actuated when there is a lane change that is intended by the driver.

16. The device according to claim 15, wherein the directional indicator includes a blinker.
